(19) United States
(12) Patent Application Publication
(10) Pub. No.: US 2016/0335930 A1
(43) Pub. Date: Nov. 17, 2016

(54) Signage

(71) Applicant: Khalil Mahmoud Abu Al-Rubb, London (GB)

(72) Inventor: Khalil Mahmoud Abu Al-Rubb, London (GB)

(21) Appl. No.: 15/151,048

(22) Filed: May 10, 2016

(30) Foreign Application Priority Data
May 11, 2015 (LU) 92713

(51) Int. Cl. G09F 7/16

(52) U.S. Cl. CPC G09F 7/16; G09F 2007/186

(57) ABSTRACT

Direction signage comprising an indicator for indicating a direction and a representation of depth wherein the indicator is orientated relative to the representation of depth so that the direction indicated by the indicator comprises a direction of forwards.

### CROSS-REFERENCE TO RELATED APPLICATIONS

This application claims priority from Luxembourg Patent Application No. 92713, filed May 11, 2015, which is incorporated by reference herein in its entirety for all purposes.

### TECHNICAL FIELD

Embodiments of the invention relate to signage, and in particular, signage as used for indicating a direction.

### BACKGROUND

FIG. 1 illustrates a direction sign 10 as known in the prior art. The direction sign comprises a place indicator 12 which is here “Food Court” and a direction indicator in the form of an arrow 14.

In use, the sign 10 is attached to a post, a wall or suspended from the ceiling so that it is visible to people seeking direction assistance. In this orientation, the arrow can have at least two meanings. In a first meaning, the arrow is intended to indicate that the place indicated (in this instance, the food court) is behind the sign so that the informee should walk towards the sign and carry on in that direction. However, the same sign may also be used in the vicinity of stairs, an elevator or an escalator to indicate that the informee should proceed up to reach the indicated place.

Since this sign is place and context dependent it can be inherently confusing, particularly where it is possible to continue on or to go up.

Embodiments of the current invention reduce this confusion therefore reducing the effort required to reach a desired location and thereby providing more efficient direction signage.

### SUMMARY

A first embodiment of the invention extends to direction signage comprising an indicator for indicating a direction and a representation of depth wherein the indicator is orientated relative to the representation of depth so that the direction indicated by the indicator comprises a direction of forwards.

The representation of depth may comprise at least one quadrilateral shape and at least one obliquely orientated line.

The representation of depth may comprise more than one obliquely orientated line.

The representation of depth may comprise four obliquely orientated lines.

The at least one obliquely orientated line may be located adjacent a corner of the quadrilateral shape.

The representation of depth may comprise two quadrilateral shapes wherein said oblique line may be orientated between corresponding corners of the two quadrilateral shapes.

The representation of depth may comprise a first quadrilateral shape located within a second quadrilateral shape, the representation of depth may further comprise at least two oblique lines, wherein each oblique line connects a corner of the first quadrilateral shape to a corresponding corner of the second quadrilateral shape.

The direction signage may comprise four oblique lines connecting corners of the first quadrilateral shape to corresponding corners of the second quadrilateral shape.

One or more of the oblique lines may be orientated between 30 and 60 degrees to a vertical, or between 110 and 150 degrees to the vertical.

The quadrilateral shape, or each quadrilateral shape, may be a rectangle or a square.

The direction signage may comprise at least two indicators of direction, wherein each indicator is orientated between 30 and 60 degrees to a vertical, or between 110 and 150 degrees to the vertical.

The direction signage may comprise four indicators of direction, wherein each indicator is orientated between 30 and 60 degrees to a vertical, or between 110 and 150 degrees to the vertical.

The orientation of any one, or more, of the indicators of direction may be: between 30 and 60 degrees to the vertical; between 110 and 150 degrees to the vertical; between 40 and 50 degrees to the vertical; between 130 and 140 degrees to the vertical; 45 degrees to the vertical; or 135 degrees to the vertical.

The indicators of direction may comprise arrows pointing towards a central region.

The indicators of direction may comprise said representation of depth.

The direction signage may comprise a substrate and printing or markings applied to the substrate, wherein said indicators of direction and said representation of depth are comprised of said printing or markings.

The substrate may define a two dimensional surface and said printing or markings may be applied to said two dimensional surface.

### DESCRIPTION OF ACCOMPANYING FIGURES

Embodiments of the invention are described with reference to the accompanying schematic diagrams where:

FIG. 1 illustrates a direction sign according to the prior art;

FIGS. 2 to 5 illustrate direction signage according to embodiments of the invention;

FIG. 6 illustrates the use of a direction sign according to an embodiment of the invention; and

FIG. 7 illustrates the direction sign of FIG. 6.

### DESCRIPTION OF EMBODIMENTS

FIG. 2 illustrates direction signage 20 comprising a substrate 22 on which various markings 24 have been adhered. It is to be realised that all of the embodiments of direction signage described herein comprise markings adhered to a substrate. The manner in which such direction signage is made is known in the art and will not be further discussed.

In the direction signage 20, the markings 24 comprise four arrows: 26, 28, 30 and 32. Dashed line 42 indicates the vertical direction when the direction signage is in use. The arrow 26 is orientated at an angle 34 to the vertical. Similarly, arrow 28 is orientated at an angle 36 to the vertical; arrow 30 is orientated at an angle 38 to the vertical; and arrow 32 is orientated at an angle 40 to the vertical. Angles 34 and 36 are 45°, angle 34 being measured in a counter-clockwise direction, and angle 36 being measured in a clockwise direction. Angles 38 and 40 are 135° angle 38 being measured in a counter-clockwise direction, and angle 40 being measured in a clockwise direction. In further embodiments

Each of the arrows 26, 28, 30 and 32 point towards a blank central region 46 on the direction signage 20. In this embodiment, the orientation of the arrows 26, 28, 30 and 32 relative to the border 44 of the direction signage 20 makes it clear that the direction indicated is forwards. The oblique orientation of the arrows 26, 28, 30 and 32 creates a form of perspective in the direction signage 20 thereby making it clear that the informee is to proceed forwards. Since the informee is facing the direction signage 20, the forwards direction will indicate a direction behind the direction signage 20.

Therefore, the arrows 26, 28, 30 and 32 create a representation of depth by adding a perspective to the flat, two-dimensional direction signage 20.

FIG. 3 illustrates a direction signage 50 according to a further embodiment of the invention. The direction signage 50 is similar to the direction signage 20 of FIG. 2 and similar features are denoted with similar reference numerals. The direction signage 50 comprises four arrows: 54, 56, 58 and 60 which are orientated in the same angle and direction as corresponding arrows 26, 28, 30 and 32 of FIG. 2. However, the arrows 54, 56, 58 and 60 differ from the arrows 26, 28, 30 and 32 of FIG. 2 in that they are shorter.

The direction signage 50 further comprises a box 52 located at the centre of the direction signage 50. The arrows 54, 56, 58 and 60 lie on imaginary lines joining the corners of the border 44 of the direction signage 50 and corresponding corners of the box 52.

In this embodiment therefore, the box 52 acts as the place indicator instead of the central region 46 of the direction signage 20 of FIG. 2. However, the arrows 54, 56, 58 and 60 serve to indicate direction and represent depth, as for the direction signage 20 of FIG. 2.

FIG. 4 illustrates a direction signage 70 according to a further embodiment of the invention. The direction signage 70 is similar to the direction signage 20 of FIG. 2 and similar features are denoted with similar reference numerals.

The direction signage 70 comprises four oblique lines 72, 74, 76 and 78 and a box 80. The box 80 is located at a central region of the direction signage 70. The direction signage 70 further comprises an arrow 82 which is located between oblique line 78 and oblique line 76, and is located outside of box 80.

In this embodiment, the box 80, together with the oblique lines 72, 74, 76 and 78 form a representation of depth since they together create the impression of a corridor. The arrow 82 acts as an indicator indicating the direction. Since an informee viewing the direction signage 70 will be generally orientated so that they are facing the direction signage 70, the arrow 82 will indicate a direction of forwards (i.e. behind the direction signage 70).

FIG. 5 illustrates a direction signage 90 according to a further embodiment of the invention. The direction signage 90 comprises two oblique lines 92 and 94 and a box 96. The box 96 is located at a central region of the direction signage 90. The direction signage 90 further comprises an arrow 98 which overlaps a bottom edge of the box 90.

In this embodiment, the box 96, together with the oblique lines 92 and 94 form a representation of depth since they together create the impression of a corridor. The arrow 98 acts as an indicator indicating the direction. Since an informee viewing the direction signage 90 will be generally orientated so that they are facing the direction signage 90, the arrow 98 will indicate a direction of forwards (i.e. behind the direction signage 70).

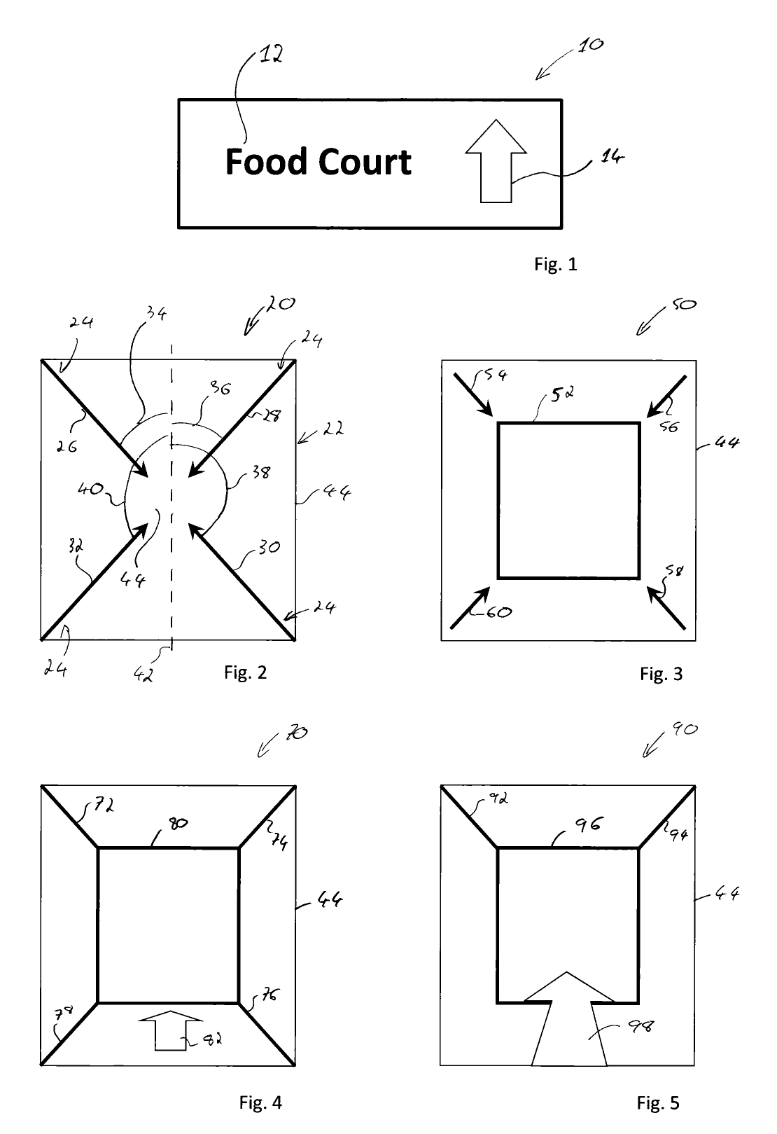

In the embodiments of FIGS. 1 to 4, the oblique lines or arrows link the corners of the respective signage, either directly or indirectly. However, it is to be realised that a quadrilateral shape may take the place of the outer border 44 of the signage of the Figures. This would allow the signage to be printed (or otherwise adhered) to other shapes and to incorporate further information such as a destination name or type.

In a further embodiment, the destination is indicated in the box, or in the central region.

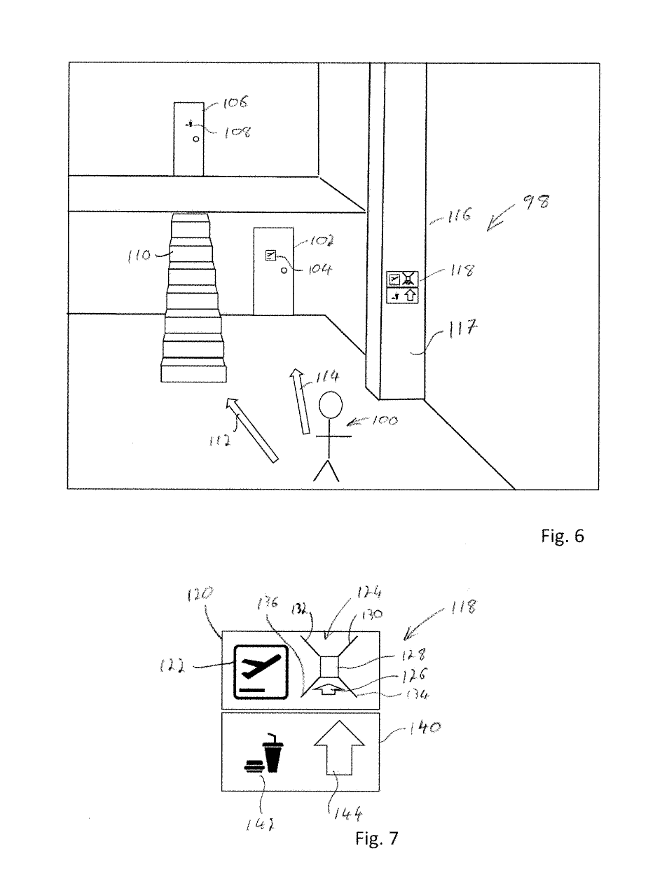

FIG. 6 illustrates a user or informee 100 in an airport. Door 102 leads to the departure area as indicated by departure sign 104. Door 106, located on the first floor, leads to a food court as shown by food court sign 108. In order to reach door 102, the informee 100 will have to proceed in the direction indicated by arrow 114 (straight ahead). However, to reach door 106, the informee will have to proceed up the stairs 110 in the direction indicated by arrow 112 (upwards).

A direction signage installation 98 is located near an area where the informee 100 is faced with the choice between the two directions. The direction signage installation 98 comprises direction signage 118 mounted to the vertical surface 117 of a pillar 116. It is to be realised that for embodiments of the invention, it is important that the direction signage of a direction signage installation is orientated vertically with respect to the informee, as illustrated in FIG. 6. Therefore, other ways of mounting the signage could be used. For example, the signage could be suspended from the ceiling or have a stand for resting on the floor, or any other known methods for mounting vertically-orientated signage.

FIG. 7 illustrates the direction signage 118 in further detail. The direction signage 118 comprises two place signs 120 and 140.

Each of the place signs 120 and 140 comprises two portions: an information icon and a direction signifier. For the place signage 120, the information icon is a departure sign 122. The direction signifier is a direction signage 124 similar to the embodiment illustrated in FIG. 4. The direction signage 124 comprises four oblique lines 130, 132, 134 and 136 joined to the corners of a box 128. An arrow 126 is located in the space between oblique lines 136 and 134.

In this embodiment, the box 128, together with the oblique lines 130, 132, 134 and 136 form a representation of depth since they together create the impression of a corridor. The informee 100 viewing the direction signage 124 is facing the direction signage 124 and therefore, the arrow 126 will indicate a direction of forwards (i.e. behind the direction signage 118 in the direction of arrow 114 of FIG. 6).

The place sign 140 comprises a food court sign 142 as an information icon and an arrow 144 as the direction signifier. In the context of FIG. 6, the arrow 144 points upwards since the sign 118 is orientated vertically. Therefore, the arrow 144 indicates to the informee 100 to follow the direction of arrow 112 to reach the food court.

This manner, embodiments of the invention indicate to a user or informee the difference between the direction of vertically upwards and a direction of straight ahead.

1. Direction signage comprising a direction indicator indicating a direction and a depth indicator representing a depth, wherein the direction indicator is orientated relative to the depth indicator so that the direction indicated by the direction indicator and visually perceived by an informee comprises a direction of forwards.

2. The direction signage according to claim 1 wherein the depth indicator comprises at least one quadrilateral shape and at least one obliquely orientated line.

3. The direction signage according to claim 2 wherein the depth indicator comprises more than one obliquely orientated line.

4. The direction signage according to claim 3 wherein the depth indicator comprises four obliquely orientated lines.

5. The direction signage according to claim 2 wherein the at least one obliquely orientated line is located adjacent a corner of the quadrilateral shape.

6. The direction signage according to claim 2 wherein the depth indicator comprises two quadrilateral shapes wherein said oblique line is orientated between corresponding corners of the two quadrilateral shapes.

7. The direction signage according to claim 2 wherein the depth indicator comprises a first quadrilateral shape located within a second quadrilateral shape, the depth indicator further comprising at least two oblique lines, wherein each oblique line connects a corner of the first quadrilateral shape to a corresponding corner of the second quadrilateral shape.

8. The direction signage according to claim 7 comprising four oblique lines connecting corners of the first quadrilateral shape to corresponding corners of the second quadrilateral shape.

9. The direction signage according to claim 2 wherein the quadrilateral shape, or wherein each quadrilateral shape, is a rectangle or a square.

10. The direction signage according to claim 1 comprising at least two direction indicators, each of which orientated between 30 and 60 degrees to a vertical, or between 110 and 150 degrees to the vertical.

11. The direction signage according to claim 10 comprising four direction indicators, wherein each of the direction indicators is orientated between 30 and 60 degrees to a vertical, or between 110 and 150 degrees to the vertical.

12. The direction signage according to claim 10 wherein the direction indicators comprise arrows pointing towards a central region.

13. The direction signage according to claim 10 wherein the direction indicators comprise said depth indicator.

14. The direction signage according to claim 2 comprising a substrate and markings applied to the substrate, wherein said direction indicators and said depth indicator are comprised of said markings.

15. The direction signage according to claim 14 wherein the substrate defines a two dimensional surface and wherein said markings are applied to said two dimensional surface.

16. The direction signage according to claim 2 wherein the direction signage is orientated vertically with respect to the informee.

17. The direction signage according to claim 16 wherein the direction signage is mounted to a wall or other vertical structural surface.

18. The direction signage according to claim 16 wherein the direction signage is mounted to a stand on a floor.

19. The direction signage according to claim 16 wherein the direction signage hangs from a ceiling.

20. A place sign comprising an information indicator and a direction signage as recited in claim 1, wherein the direction signage is disposed adjacent to the information indicator.
